(19) United States
(12) Patent Application Publication
(10) Pub. No.: US 2015/0375463 A1
(43) Pub. Date: Dec. 31, 2015

(54) MOLDING APPARATUS, MOLDED ARTICLES, AND METHODS OF MOLDING

(71) Applicant: W Sidney DuBinion, Burnsville, MN (US)

(72) Inventor: W Sidney DuBinion, Burnsville, MN (US)

(21) Appl. No.: 14/852,078

(22) Filed: Sep. 11, 2015

Related U.S. Application Data
(63) Continuation of application No. PCT/US14/30973, filed on Mar. 18, 2014.
(60) Provisional application No. 61/852,550, filed on Mar. 18, 2013.

(51) Int. Cl. B29C 70/44; C08J 5/00

(52) U.S. Cl. CPC B29C 70/44; C08J 5/00; B29K 2069/00

(57) ABSTRACT

A mold assembly having a reversibly pressurized inner membrane disposed within the molding cavity is used to mold thermoplastic or thermoset articles. The use of the pressurized inner membrane enables the molding to be carried out below the melt temperature of a thermoplastic in some embodiments. The mold assembly and methods of molding enable the formation of molded articles, including complex articles, with improved properties compared to articles formed using conventional apparatuses and methods.

### CROSS-REFERENCE TO RELATED APPLICATIONS

This application claims priority to PCT Application No. PCT/US2014/030973, filed Mar. 18, 2014, entitled MOLDING APPARATUS, MOLDED ARTICLES, AND METHODS OF MOLDING, which claims priority to U.S. Application No. 61/852,550, filed Mar. 18, 2013, each of which is incorporated herein by reference in its entirety.

### FIELD OF THE INVENTION

The present invention relates to methods of molding articles from engineering thermoplastics such as polycarbonate. The present invention further relates to post-molding treatment processes.

### BACKGROUND

Thermosets and thermoplastic materials are conventionally processed by methods including, for example, blow molding, calendaring, thermoforming, extrusion, pultrusion, cavity injection, injection molding, gas assisted injection molding, compression molding, rotomolding, casting, float casting, slush casting, filament winding, removable core, and lost core. While certain engineering thermoplastics, such as polycarbonate, have highly desirable material properties in theory, standard molding processes do not work to form articles from these materials wherein these properties are translated satisfactorily to the finished article. In particular, the formation of complex articles present a challenge for such materials. Complex articles are those having one or more of large overall dimensions, such as vehicle parts or architectural elements, tight tolerances, large wall thicknesses, angular three-dimensional features, and high aspect ratios. An example of a molded article including a plurality of complexities is a vehicle unibody, such as an automobile frame or an airplane fuselage.

Conventional thermoplastic molding techniques include many limitations to making complex geometries. For example, conventional molding includes solid, fixed mold boundaries, wherein cooling of the molten polymer after molding leads to shrinkage. Shrinkage induces stress and loss of tolerance in the resulting article. Conventionally molded complex parts tend to have localized or generalized low tensile and/or compressive strength, high circumferential stress, low hardness, and low wear resistance Residual stresses and compromised properties further lead to poor aging performance. Further, in order to force molten material into corners and small spaces and completely fill a mold, vents in the mold must be provided; some polymer flows into the vents and this in turn leads to expensive post processing and appreciable waste (flash).

LeGrand, D. and Bendler, J., eds., Handbook of Polycarbonate Science and Technology, 2000, Marcel Dekker, NY, N.Y. report time-dependent volume relaxation predictions due to imposed stress in molded polycarbonate. The effects predicted by the authors would translate to changing properties with aging. Constraining volume or linear relaxation expansion would ameliorate this time-dependent instability.

Some post-molding processes have been developed to improve properties of thermoplastic articles. Cold rolling is a post-molding technique known by metalworkers to increase strength via strain hardening. The technique involves reducing the thickness of a sheet article, sometimes as much as 50%, at a temperature below the crystallization temperature by passing through a two-roll nip. Broutman, L. et al., J. Pol. Sci. and Eng. 14(12) (1974) 823-826 report increased toughness due to cold rolling of some amorphous polymers. However, this technique is available only for polymers that are molded in sheet or film form.

Seguchi T., et al., Rad. Phys. And Chem., 63 (2002) 35-40 report selective gamma irradiation of polycarbonate significantly increases hardness and wear resistance.

Teijin Limited (http://www.teijin.com/news/2014/ebd140221_{—}42.html) in cooperation with Nissan Shatai Co. Ltd reports thick wall injection press technology for producing distortion free, thick wall flat sections. The partnership further reports a three dimensional post processing glazing for hard coating.

Engel Austria GmbH (Kunststoffe 4/2009, pp. 30-34; translation available at www.kunststoff-international.com, as Document No. PE 110084) reports injection compression molding increases part adherence to tolerances thereby increasing reproducibility and by use of isochoric cooling reduces residual stresses, thereby maintaining reproducibility. By use mold pressures and maintaining distances between the mold sections, Engel forces the melt to conform to mold boundaries. By controlling heat electrically and using isochoric cooling, Engel reduces residual stresses, thereby improving part accuracy.

The University of Alicante (Lozano, V., “Technology Offer: Know How for Gas Assistend Injection Moulding Technology”, Universitat d'Alacant, available online at http://sgitt-otri.ua.es/es/empresa/ofertas-tecnologicas.html) reports gas-assisted injection moulding (GAIM), while related to blow molding, has significantly different properties and applications. As compared to conventional injection molding, the University reports the following advantages: use of lower tonnage machines, lower injection pressures, improved part quality, reduced cycle time vs solid sections, high strength to weight ratio, reduced/eliminated sink, less warpage, low molded-in stress, excellent dimensional stability, and design flexibility.

### SUMMARY

Disclosed herein is a flexible, reversibly pressurized membrane based mold apparatus and molding techniques for making thermoplastic articles with improved physical properties. The mold includes outer shell and an expandable inner membrane. In some embodiments the inner membrane is gas expanded. In other embodiments the inner membrane is hydraulically expanded. Gas or hydraulic fluid is injected into the membrane through a portal to form a compressing interior wall; the gas or fluid is then withdrawn via the portal upon completion of molding. In some embodiments, conventional split solid mold sections define the exterior boundary of the article. In some embodiments both the solid mold sections and the expandable membrane are electrically conductive, heat conductive, or both whereas electricity passed through them provide rapid and homogeneous heating of the entirety of the mold apparatus. The solid mold sections and the expandable membrane cooperate to produce a conforming inner boundary which is solid and stable when the membrane is pressurized.

In some embodiments, electric current flows through the exterior fixed boundaries and the one or more membranes to provide heat and pressure, as required and selected by a user, for both in situ pre-drying of the moldable materials as well as for the molding itself. The electric current and pressure are further modulated during molding and during cooling subsequent to the molding, to provide a fully customizable process.

In some embodiments, the mold assembly of the invention is employed in a process of forming an article wherein the article is not melt flow processed, but rather wherein the polymer is conformed using pressure at a temperature between T_{g} (glass transition temperature) and Tₘ (melt temperature). This method offers numerous advantages over conventional melt flow methodology for a broad range of molded polymeric articles.

In some embodiments, reinforcing elements which are compatible with both the molding process and the final article are added to the mold and impart significant additional strength to the article.

Also disclosed herein is a technique of carrying out one or more additional cycles of relaxation and high pressure expansion of the molding membrane after molding and prior to de-molding. This technique mimics the effect of cold rolling, wherein impact strengthening of the thermoplastic is imparted to articles that are not in sheet form, and without the need for a completely separate apparatus to achieve the benefit of increased impact strength.

In some embodiments the mold assembly includes one or more ejection membranes. The ejection membranes are quiescent during the molding process and are inflated after molding and cooling the formed article, simplifying article removal and obviating the need for release agents.

Also disclosed herein is an external radioactive sleeve populated with an isotope such as Co⁶⁰. The sleeve emits gamma rays, wherein the strength and duration of γ-irradiation is controlled by population density and time of sleeve deployment to impart a significant hardness increase of the outer boundaries of the molded article after completion of molding. In embodiments, the sleeve is affixed to the outside of the mold, wherein the gamma radiation generated is able to penetrate to the interior mold cavity without significant attenuation.

Using the described molding apparatus and methods, molded articles conventionally formed from metals and/or composites such as thermoset/carbon fiber composites, are made from thermoplastics, including engineering thermoplastics, or from thermosetting polymers that cure during molding. Highly toleranced (precision) articles and complex articles, including unibodies, are easily achieved in a single apparatus and without the need for secondary operations. Coupled with significant processing productivity gains, these processes and apparatuses give manufacturers integrated options for reducing the challenge of going from pellets and/or syrups to final articles. Additionally, the processes and apparatuses provide new avenues to engineering thermoplastic use in a wide range of articles, wherein improved properties in the finished article are realized. Additionally, the thermoplastic charge is advantageously delivered to the mold on a precise gravimetric basis, because no flash is produced and no shrinkage occurs upon cooling.

### BRIEF DESCRIPTION OF THE DRAWINGS

FIG. 1A is a schematic view of some elements of a mold assembly of the invention.

FIG. 1B is a cutaway view of a portion of an assembly element of FIG. 1A, taken along the line A-B.

FIG. 1C is a schematic view of some elements of a mold assembly of the invention.

FIG. 2 is a schematic view of closed mold assembly of the invention.

FIG. 3 is a schematic representation of a Co⁶⁰ infused sleeve covering a mold assembly of the invention.

FIG. 4 is a cutaway view representation of a molded article demolded from the mold assembly of the invention.

FIG. 5 is a schematic representation of a portion of the mold assembly of the invention.

### DETAILED DESCRIPTION

Various embodiments will be described in detail with reference to the drawings. Reference to various embodiments does not limit the scope of the claims attached hereto. Additionally, any examples set forth in this specification are not intended to be limiting and merely set forth some of the many possible embodiments for the appended claims.

As used herein, “complex article” means a three-dimensional article having a geometry characterized by one or more of large size, substantial wall thickness, high aspect ratio, tight tolerance, sharp angle, large internal cavity (that is, a large ratio of the volumes described by the inner:outer boundaries of the article), or irregularly shaped cavity. In this context, “large” size means having least one dimension that is about 2 meters or greater. In this context, “substantial” wall thickness means a wall having a thickness of about 3 cm or greater. In this context, “tight” tolerance means a tolerance of about 25 μm or less. In this context, “sharp” angle means an angle of about 45° or less. In this context, “large” cavity means the volume defined by the inner boundary of the article is 90% or greater of the volume defined by the outer boundary. In this context, “irregularly shaped” means a shape not defined by symmetry.

“Complex article” further means an article wherein uniform property distribution, maintenance of transparency or translucency, or both are not achievable using conventional molding methodologies.

As used herein, the word “substantially” modifying, for example, the type or quantity of an ingredient in a composition, a property, a measurable quantity, a method, a position, a value, or a range, employed in describing the embodiments of the disclosure, refers to a variation that does not affect the overall recited composition, property, quantity, method, position, value, or range thereof in a manner that negates an intended composition, property, quantity, method, position, value, or range. Intended properties include, solely by way of nonlimiting examples thereof, thickness, ductility, toughness, and the like; intended positions include disposition of a molded article, or the positioning of various components of a mold assembly. The effect on methods that are modified by “substantially” include the effects caused by any type or amount of materials on the temperature or pressure profile, or methods of molding, wherein the manner or degree of the effect does not negate one or more intended properties or results; and like proximate considerations. Where modified by the term “substantially” the claims appended hereto include equivalents to these types and amounts of values.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and molding procedures; through inadvertent error in these procedures; through differences in the manufacture, source, or purity of starting materials or ingredients used to carry out the methods, and like proximate considerations. The term “about” also encompasses amounts that differ due to aging of a material with a particular initial property, and amounts that differ due to mixing or processing a material. Where modified by the term “about” the claims appended hereto include equivalents to these quantities.

Advantages

Engineering thermoplastics are characterized by high modulus and ductility. A combination of high molecular weight, interchain interactions (typically polar interactions), and crystalline/glassy balance provide these properties. A typical example of an engineering thermoplastic is polycarbonate. The melt flow characteristics of polycarbonates and many other engineering thermoplastics, due to their high molecular weight and high level of internal chemical interactions, are unsuitable for molding complex articles. Typically, a plastic such as polycarbonate is heated to melting and forced at high pressure into a mold. Relatively low melt flow (compared to e.g. low viscosity materials such as water) limits the ability of polymeric materials to conform to complex mold geometries. In some embodiments, additional additives such as plasticizers are required to cause the polymer to flow sufficiently to properly fill a mold in the molten state.

A first advantage of the molding apparatuses and molding methods described herein is that there is no particular requirement of melt flow. Therefore, many polymeric materials that previously could not be thermally molded are moldable using the apparatuses and methods of the invention. Further, materials such as polycarbonate which are widely used for molding but are unsuitable for molding into complex articles are moldable to form complex articles using the apparatuses and methods described herein.

A second advantage is the use of the molding apparatus as a preprocessing dryer and a mold in one cavity. By using a low current flow and a low gas or fluid pressure in the pressurized membrane, the polymer powder, syrup, or pellets are suitably dried in situ antecedent to high temperature and high pressure molding.

A third advantage is the use of the molding apparatus for post processing. Using active current heating of both the shell and membrane portions of the molding apparatus, precise annealing of the article is accomplished by a precisely controlled heating program, leading to improved part quality and homogeneity.

A fourth advantage is the use of the molding apparatus to simulate the effect of cold rolling a thermoplastic article. Cold roll simulation is easily accomplished by modulating the membrane pressure in or out of concert with the aforementioned annealing step. Additionally, this technique allows for cold roll type processing for non-sheet form articles, including complex articles.

A fifth advantage is a molded polymeric material of improved integrity by the use of lower molding temperatures and less molding time. Because the article is not melt flow processed, but conformed using pressure at a temperature between T_{g} (glass transition temperature) and Tₘ (melt temperature), the methods of the invention results in formation of a completed article with lower time/temperature requirements than that of conventional melt processing. Less degradation of polymer materials takes place due to both the lower temperature and the lowered time of heating. Less degradation of the polymer leads to a higher quality article. Additionally, productivity is increased due to the reduced time requirements for molding.

A sixth advantage is the use of reinforcing elements, properly situated within the moldable material disposed within the mold assembly for selective tensile reinforcement, selective hoop (circumferential) reinforcement, selective shear reinforcement, or compression stress reinforcement of the molded article. In some embodiments, the reinforcing element is a ligand. In some such embodiments, the ligand is a pre-stressed ligand. Ligands accomplish one or more of the above reinforcing effects.

A seventh advantage is ease of demolding of the molded article. Conventionally, mold release agents, and/or mold geometries such as sprues, runners, and vents are used for this purpose. Using the molding apparatus of the present disclosure, de-molding of an article is brought about automatically through gas pressure relaxation and subsequent everting of the inner membrane. Optionally, the use of an outer membrane connected to the mold shell for the purpose of assisting in demolding is employed, wherein the outer membrane is inflated to urge the article away from the outer boundary of the mold. Thus, the use of both mechanical release assists and chemical mold release agents, which can foul the mold, affect surface properties of the article, and contribute to thermal or other degradation, is obviated.

An eighth advantage is improved tolerance limits of the articles formed using the methods disclosed herein. In an exemplary embodiment, as an article progresses through a melt/cool profile within the molding apparatus, the membrane pressure is increased to maintain exterior margin geometry, thereby obviating the normal shrinkage problem normally incurred with fixed boundary thermoplastic molding technology.

A ninth advantage is the long term aging characteristics of articles formed using the methods disclosed herein. Processing below the melt temperature of the polymeric materials, coupled with the removal of stress due to shrinkage of the article during cooling, leads to articles with inherently superior aging characteristics from both the material integrity standpoint as well as the integrity of the article itself. Further, the use of reinforced ligands in some embodiments precludes the three axis volume displacement associated with aging, providing overall superior aging behavior of articles without the use of compounding alternatives and additives.

A tenth advantage is the ability of the apparatus to maintain an inner boundary, via the inner membrane, by expanding the inner membrane after molding and during cooling, to maintain contact and pressure on the article as it cools. Such a process precludes the formation of internal stresses due to melt shrinkage.

An eleventh advantage is reduced or non-existent flash as excess fill shot is not required in order to compensate for shrinkage. Therefore, fill maybe delivered on a gravimetric basis and secondary flash processing and cleanup is obviated.

A twelfth advantage is the use of a removable cobalt (Co⁶⁰) embedded sleeve for article irradiation, which imparts a significant increase in hardness and wear resistance. The irradiation does not have to be a separate operation; the article is suitably irradiated in situ prior to de-molding by applying the sleeve over the mold apparatus.

As plastic articles are, in many embodiments, lightweight or inexpensive substitutes for wood, metals, or composites of these materials, transportation craft such as aircraft, ground transport vehicles, and water transport vehicles will benefit from the presently disclosed methods and apparatuses. By using the methods and apparatuses as described herein, improved properties such as lower weight requirements, higher ductility, low creep, crack avoidance, improved overall property uniformity, and improved transparency or translucency in some applications, coupled with a lower cost of processing to final shape and size and a faster time to completion when compared to conventional processing methodologies and apparatuses known to those of skill.

Apparatus

The apparatus of the invention is a membrane based mold assembly. The mold assembly includes first and second mold shell sections adapted to be attached to form a mold shell defining a cavity; and a reversibly pressurized inner membrane fluidly connected to a source of pressure, wherein the assembly is formed by disposing the inner membrane within the cavity such that the cavity defines the outer boundary of an article to be molded, and the pressurized inner membrane defines the inner boundary of the article to be molded.

The mold shell has first and second mold shell sections, wherein each mold shell section defines a hollowed area (first and second hollowed areas) defining a portion of an outer boundary (first and second outer boundaries) of the desired shape of the article to be molded. Each mold shell section is formed from steel, aluminum, titanium, or an alloy having properties similar to one or more of these, or a high-melting or thermoset polymeric material such as e.g. a polyimide, glass/ceramic, and the like. The first and second mold shell sections are adapted and designed to fasten together to form the mold shell defining a cavity that defines the complete outer boundary of the shape of the article to be molded, wherein the fastening is accomplished by bolts, clips, pins, or the like and is not particularly limited.

In some embodiments, the mold assembly is heated during molding operations by placing the mold assembly in an oven or by placing heating elements in contact with the mold assembly. In other embodiments the mold shell sections are adapted to be heated. In some embodiments the mold shell sections conduct electricity, and heating is accomplished using direct resistive heating by passing electricity through the mold sections. In other embodiments the heating is accomplished indirectly by embedding heating elements within the mold sections, running heated fluid through conduits present within the mold sections, or the like. In still other embodiments heating is accomplished by employing transparent or translucent mold sections and inner membrane, and exposing the mold apparatus to electromagnetic radiation such as microwaves, infrared radiation, and the like. One or both of the mold shell sections define a portal adapted for positioning of an inner membrane therein. The portal is shaped, in some embodiments, to provide a suitable feature of the article to be molded. In some embodiments, the portal includes a portal door that serves to isolate the inner membrane, for example when pressurized.

In some embodiments, one or more thermocouples are present within one or both of the mold shell sections. In some embodiments, the mold shell sections are formed from a high-melting or thermoset polymeric material and further contain carbon fibers in order to apply direct resistive heating to the mold shell sections. In some embodiments, the application of heat to the mold shell sections is controlled by a computer algorithm; in other embodiments, the application of heat is controlled manually.

When pressurized, the reversibly pressurized inner membrane defines the inner boundary of the desired shape of the article to be molded. The inner membrane is fluidly connected to a source of gas or hydraulic pressure. When disposed within the mold assembly, the inner membrane is fluidly connected via the portal to a source of gas or hydraulic pressure. In embodiments, the pressure source resides outside the mold assembly. The location of the connection between the inner membrane and the pressure source is not particularly limited with respect to the mold assembly, and occurs or outside the mold assembly, or within the portal, or is the portal itself. In some embodiments, the source of pressure is e.g. a pressurized gas cylinder, and the fluid connection of the inner membrane to the cylinder includes a relief valve to release the pressure after molding an article. In other embodiments, the source of pressure is a reservoir that is reversibly pressurized, and a sealed path between the inner membrane and the reservoir is formed, wherein a fluid (i.e. a gas or hydraulic fluid) is transferred from the inner membrane after molding, to reservoir after molding; and the inner membrane-reservoir connection defines a sealed system. In such embodiments, the sealed system further requires the action of a pump or other apparatus to transfer the fluid to the inner membrane, from the inner membrane, or both to and from the inner membrane. In some embodiments, the inner membrane is everted after completion of molding, causing a vacuum to form within the mold assembly; in such embodiments, the formation of the vacuum causes or assists in causing demolding of the molded article.

The inner membrane is formed from a material sufficiently flexible to be reversibly activated by inflation, deflation, and optionally eversion actions caused by the addition or subtraction of gas or hydraulic pressure. When fully inflated by the gas or hydraulic pressure, the inner membrane is able to withstand pressures of about 650 kPa to 3500 kPa and must also be capable of exposure to heat sufficient to carry out the molding without melting, bursting, or degrading. In some embodiments the inner membrane includes an elastomeric material; alternatively, one suitable material used to form an inner membrane is polyimide film. In some embodiments the inner membrane includes reinforcing members such as scrims, fibers, and the like. In some embodiments, the inner membrane is adapted to be heated; in some such embodiments, the inner membrane is adapted to conduct electricity. Conductivity is suitably imparted, in some embodiments, by embedding carbon fibers within the material used to form the inner membrane.

In some embodiments, the membrane includes one or more thermocouples, one or more pressure sensors, or both. In some embodiments, the source of gas or hydraulic pressure is controlled by a computer controller (algorithm); in some such embodiments, pressure measurements from one or more pressure sensors is transmitted to the controller. In other embodiments, the source of gas or hydraulic pressure is manually controlled.

Additional elements of the mold apparatus are envisioned for use in some embodiments.

In some embodiments, one or both of the mold shell sections includes an outer membrane connected at an edge portion of a hollowed area of a mold shell section, and an inlet adapted for reversible application of gas or hydraulic pressure disposed between the outer membrane and the cavity boundary. The purpose of the outer membrane is to assist in release (demolding) of the article from the mold shell after completion of molding, by applying gas or hydraulic pressure between the membrane and the hollowed area. The outer membrane is formed from a material sufficiently flexible to be reversibly activated by inflation and deflation actions caused by the addition or subtraction of gas or hydraulic pressure. When fully inflated by the gas or hydraulic pressure, the outer membrane is able to withstand pressures of about 650 kPa to 3500 kPa. One suitable material used to form an outer membrane is polyimide film. In some embodiments, the outer membrane is adapted to be heated; in some such embodiments, the outer membrane is adapted to conduct electricity. Conductivity is suitably imparted, in some embodiments, by embedding carbon fibers within the material used to form the outer membrane.

In some embodiments the outer membrane is connected to the same source of gas or hydraulic pressure as the inner membrane. In other embodiments the outer membrane is connected a separate source of gas or hydraulic pressure as the inner membrane. In some embodiments, a sealed path between the inner and outer membranes is formed, wherein a fluid is shunted from the inner membrane after molding, to the outer membrane to cause demolding; and the inner-outer membrane connection defines a sealed system.

In some embodiments, one or more additional inner membranes are adapted to be disposed within the mold sections. In such embodiments, a portal for each inner membrane is included in the mold shell sections when the mold assembly is assembled, and each inner membrane is connected to a pressure source wherein differential pressures between the inner membranes are suitably applied as selected. The differential pressure is applied by connecting each inner membrane to a separate pressure source, or by connecting to a single pressure source and using a controller such as a computer to produce selected pressures in the different inner membranes. In some such embodiments, each inner membrane is heated and differential heat is selectively applied to the two or more inner membranes.

The mold assembly includes various pipes, valves, controllers, wires, belts, fasteners, mounts, and the like as required by the user and based on the size of the assembly, materials used to form the assembly, selected pressure source, and the like. One of skill will appreciate that within the scope of the mold assembly a variety of variations are possible. For example, in some embodiments the mold assembly is connected to a source of modulating gas supply for the controlled and reversible expansion/pressurization of the inner membrane, with associated piping and valving. In some embodiments the mold assembly is connected to a source of modulating gas supply for the outer membranes disposed within and attached to the mold shell segments, with associated piping and valving. In some embodiments the mold assembly is connected to a source of modulating electrical energy for the heating of mold shell sections, the inner membrane(s), or both, and associated wiring and controls. In some embodiments the mold assembly is connected to a coordinating, or modulating unit such as an industrial computer to sequence to the various steps of pressurizing and heating in order to carry out the molding methods described, with associated wiring and connection points to the assembly elements. In some embodiments the inner membrane(s), the outer membrane(s), or both are connected to modulating valves to provide for proper pressurization of each membrane at the precise intervals and at precise pressures.

Methods

The methods of then invention describe making a molded article using the mold assembly as described herein. The methods include adding a moldable material to a first mold shell section and a second mold shell section, each mold shell section defining a portion of a cavity; disposing a pressurized inner membrane proximal to at least the first mold shell section; attaching the first and second mold shell sections to form a mold assembly defining a cavity, wherein the inner membrane is disposed within the cavity; heating the moldable material to a temperature between the T_{g} (glass transition temperature) and Tₘ (melt temperature) of the material, above the Tₘ of the material, or to a required cure temperature, while maintaining or in some embodiments increasing pressure in the inner membrane; then removing the source of heat while maintaining or in some embodiments increasing pressure to the inner membrane.

While not serving to limit the methods advantageously employed in conjunction with the mold assemblies of the invention, it will be understood by the skilled artisan that for molding of many materials, including many commercially significant engineering thermoplastics, the methods of the invention desirably employ the maximum pressure applied to the moldable material in conjunction with minimum temperature required to form the article. Thus, in some embodiments, it is possible to mold an article at a temperature between T_{g} and Tₘ of the moldable material. In other embodiments, it is necessary to raise the temperature above Tₘ. The temperature-pressure requirement is different for each species of moldable material employed. In embodiments, the pressure applied to the moldable material is between about 0 kPa and 4000 kPa, for example between about 100 kPa and 3800 kPa, or about 500 kPa and 3500 kPa, or even about 1000 kPa and 3000 kPa.

The mold assembly includes first and second mold shell sections adapted to be attached to form a mold shell defining a cavity; and, wherein the assembly is formed by such that the cavity defines the outer boundary of an article to be molded, and the pressurized inner membrane defines the inner boundary of the article to be molded.

In embodiments, the mold assembly is assembled after a moldable material is introduced into the mold shell sections. As used herein, the term “moldable material” means a charge of thermoplastic pellets, flakes, and the like, a precursor syrup that is cured by heat activation to form a thermoplastic or a thermoset, thermoplastic pellets, flakes, and the like that are cured by heat to form a thermoset, or a mixture of two or more thereof. In some embodiments, a curable moldable material is cured by radiation, such as ultraviolet radiation, wherein the mold assembly is transparent or translucent to the wavelengths of radiation required to cure the material.

In some embodiments, one or more reinforcing elements are also placed within one or both of the mold shell sections in a manner that provides reinforcing strength to the article in its intended end use. In some embodiments, the reinforcing element is a ligand. In some embodiments the reinforcing element is a metallic wire or mesh. In some embodiments, a reinforcing element is pre-stressed. Use and placement of such reinforcing elements will depend on the intended end use of the article to be molded. In other embodiments, the reinforcing element is an organic or inorganic substance, such as a reinforcing filler, that is blended with the moldable materials in the mold shell sections. Such fillers contribute to one or more properties such as strength, rigidity, toughness, impact resistance, or ductility of the molded article.

After addition of the moldable materials and optionally one or more reinforcing elements to the mold shell sections, the inner membrane, connected to the pressure source, is disposed within the first mold shell section; then the second mold shell section is fastened to the first mold shell section to form the mold shell defining a cavity that defines the complete outer boundary of the shape of the article to be molded. The inner membrane is pressurized before disposition in the first mold shell section, or after disposition in the first mold shell section but before fastening the second mold shell section to the first mold shell section. Upon pressurization, the inner membrane defines the complete inner boundary of the shape of the article to be molded.

Upon connecting or fastening of the mold shell sections, the mold assembly is completed and the assembly is heated. In some embodiments, a current source for the mold shell sections is switched on. In some embodiments, the moldable material is dried initially via a drying cycle of heat. Upon completion of drying cycle, additional heat is applied within the mold assembly in order to reach a temperature between the glass transition temperature and the melt temperature for a thermoplastic, in some embodiments above the melt temperature for a thermoplastic, or up to a suitable cure temperature for a curable material. Pressure within the inner membrane is maintained or increased contemporaneously with the temperature increase to result in formation of a continuous layer of the moldable material that fills the space between the inner membrane and the cavity, wherein the continuous layer is characterized by the lack of void space. Upon formation of the continuous layer, the temperature inside the mold assembly is reduced and finally cooled to ambient or near-ambient temperature to result in a molded article. Where the moldable material employed is curable, the molded article is a thermoset article.

In some embodiments, in order to form a continuous layer of moldable material throughout the mold shell, the mold shell is subjected to a spinning motion, wherein centrifugal force assists with complete mold filling during heating of the mold shell. In other embodiments, the outer membrane(s) assist in filling the mold. In such embodiments, the outer membranes are pressurized during the heating to facilitate movement of the moldable materials within the boundaries defined by the inner membrane (inner boundary of the article to be formed) disposed within the mold shell cavity (outer boundary of the article to be formed). Pressurization is carried continuously for at least about 0.1 second, or up to about 10 minutes during heating; or pressurization is pulsed, for example two or more times, or up to 1000 times, to facilitate distribution of moldable material throughout the space within the mold shell not occupied by the inner membrane. Prior to reaching the cooldown portion of the process, the outer membrane(s) are depressurized in order to allow the final form of the article to be “frozen” in place.

In some embodiments, the moldable material is radiation curable. Radiation curable moldable materials are usefully employed where both the mold and the inner membrane at least are transparent or translucent to the wavelength(s) of radiation required to cure the moldable material. In some such embodiments, a photoinitiator is further included in the moldable materials by blending. In some such embodiments, upon reaching a temperature and pressure that induces complete mold filling of the moldable material, a source of radiation is used to irradiate the mold shell and cure the radiation curable moldable material. One example of this technique is to form at least one of the mold shell elements from glass or a polyimide, and form the inner membrane from polyimide; use of a moldable material that crosslinks when exposed to UV light is added to the mold cavity along with a UV activated photoinitiator. After forming the mold assembly and heating to distribute the moldable material within the boundaries defined by the inner membrane (inner boundary of the article to be formed) disposed within the mold shell cavity (outer boundary of the article to be formed), a UV lamp or set of lamps is used to irradiate the mold shell, wherein the wavelength of UV light supplied is sufficient to activate the photoinitiator and crosslink (cure) the polymer. In other embodiments, a mixture of prepolymer, monomers, and crosslinkers, also called a syrup, is placed within the boundaries defined by the inner membrane (inner boundary of the article to be formed) disposed within the mold shell cavity (outer boundary of the article to be formed) and cure is carried out by inducing both polymerization and crosslinking in a single irradiation by the radiation source.

Pressure within the inner membrane is maintained or increased as the molded article cools and shrinks, to maintain outer part tolerance and preclude shrinkage-induced internal stresses. In some embodiments, once the molded article is cooled to near-ambient temperature or ambient temperature, post processing is carried out. In some embodiments, outer surface toughening analogous to cold working is carried out by varying the pressure supplied to the inner membrane(s) and/or the outer membrane(s). In some embodiments, the pressure is varied in a cyclical manner, for example increasing then decreasing pressure 2 to 1000 times, or 5 to 500 times upon cooling and prior to demolding. In some embodiments, the pressure variation is a rapid pressure “pulse” wherein maximum pressure is maintained for about 0.5 s to 5 s for each cycle. In some embodiments, during the variation of pressure the temperature is varied from ambient temperature to a higher temperature selected to achieve the desired level of annealing and cold-roll analogous toughening. In some embodiments, the temperature is slowly decreased as the pressure is varied/pulsed over one or more cycles.

Additionally, in some embodiments a cobalt-infused sheet or sleeve is judiciously applied to cover the mold shell, or a portion thereof, to irradiate the article thereby imparting additional hardness and wear resistance to the molded article. In some embodiments, a gamma ray transparent material is used to form a sheet embedded with Co⁶⁰. Gamma ray transparent or translucent materials include certain polyurethanes. Thus, for example, in some embodiments a solution of polyurethane and Co⁶⁰ is coated on a polyurethane sheet, for example by continuous die coating or by stripe or pattern coating, and the solvent is dried to form the infused sheet. In other embodiments, a solution of polyurethane and Co⁶⁰ is used to form a heterogeneous mixture with a solution of polyurethane, wherein the combined mixtures are solution cast to form a sheet having “islands” of C⁶⁰ therein. Drying of the solvent from the casting is accomplished using drying equipment that is able to withstand gamma radiation. The dried cast sheet or sleeve, in some embodiments further cut to a selected size, is then placed on top of the mold shell, beneath the mold shell, or both prior to demolding the finished article in order to irradiate the article. Residence time of irradiation is a function of attenuation by the mold shell and/or inner membrane, species of moldable material, and amount of Co⁶⁰ embedded in the sheet or sleeve. Determination of residence time is included in the techniques set forth by Seguchi T., et al., Rad. Phys. And Chem., 63 (2002) 35-40, which is incorporated by reference herein in its entirety.

Upon completion of cooling and optional post processing steps, the finished article is demolded, that is, released from any adhesion to the cavity or the inner membrane. The inner membrane is depressurized, in some embodiments by opening the portal door to allow for pressure release, in other embodiments by releasing gas pressure via a valve, or the like. In some embodiments the inner membrane is everted, wherein depressurization or eversion leads to the formation of a vacuum in the interior of the newly exposed inner boundary of the article. This in turn urges the article away from the cavity; in some embodiments, the vacuum is sufficient to cause the article to demold. The fasteners are loosened and/or removed. Then, if the article is not already demolded, the outer membrane(s) are pressurized to cause demolding.

The mold assemblies and methods of molding articles described herein present several improvements relevant to the field of molding. First, the improved properties of the molded articles formed using the apparatuses and methods described herein, compared to articles molded by traditional molding methodology, are sufficient in some embodiments to provide for utility of thermoplastics or thermosets in applications that previously required metals. Since most thermoplastics and thermosets are significantly less dense than metals, substantial decrease in weight of various articles is realized when replacing metal with a thermoplastic or thermoset polymer. Additionally, traditional metal joining requires specialized materials such as welding gases and specialty wire blends, whereas such materials are obviated using the apparatuses and methods described herein. Second, significant productivity gains are realized by the use of the apparatuses and methods described herein, as is detailed above. Third, the apparatuses and methods described herein enable many engineering thermoplastics to be used to make complex articles, wherein conventional molding methodologies do not provide for this use of many engineering thermoplastics.

### DETAILED DESCRIPTION OF THE FIGURES

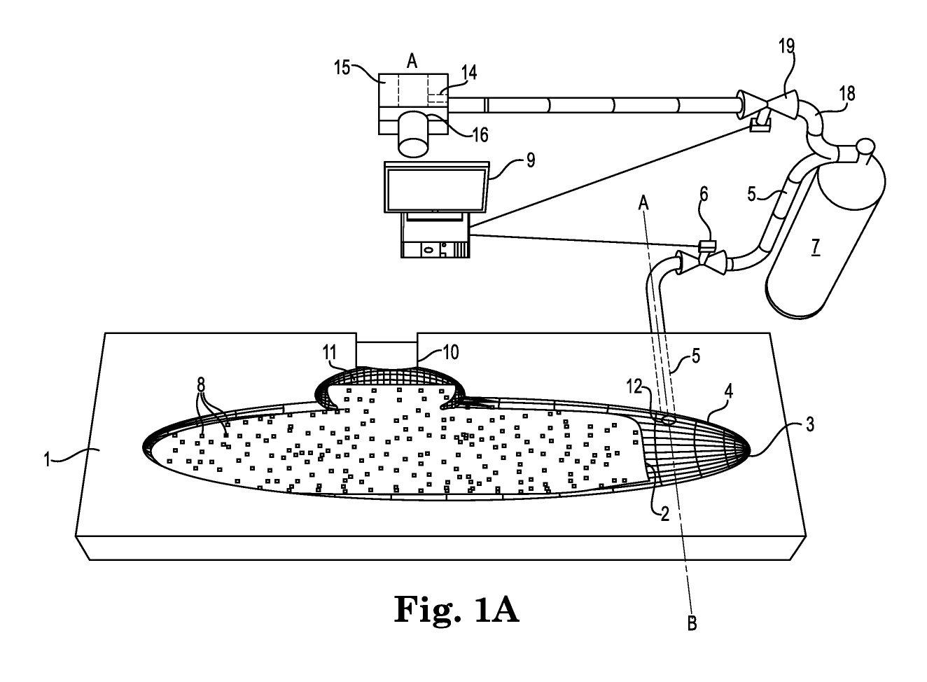

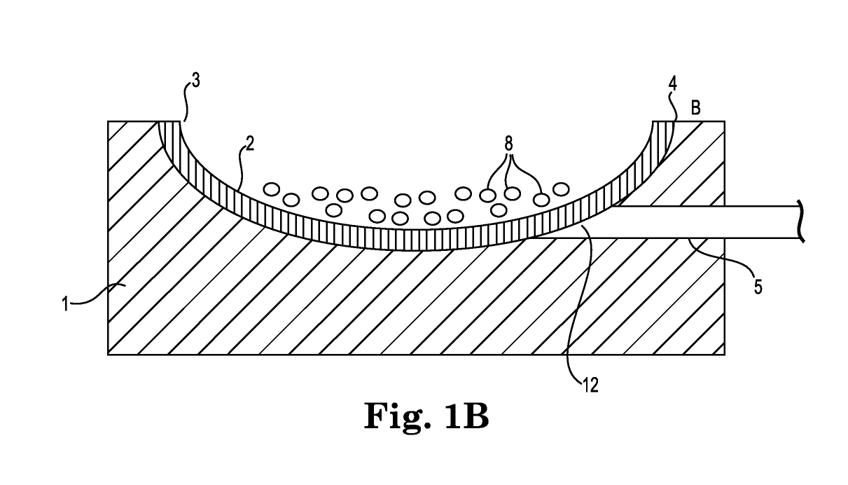

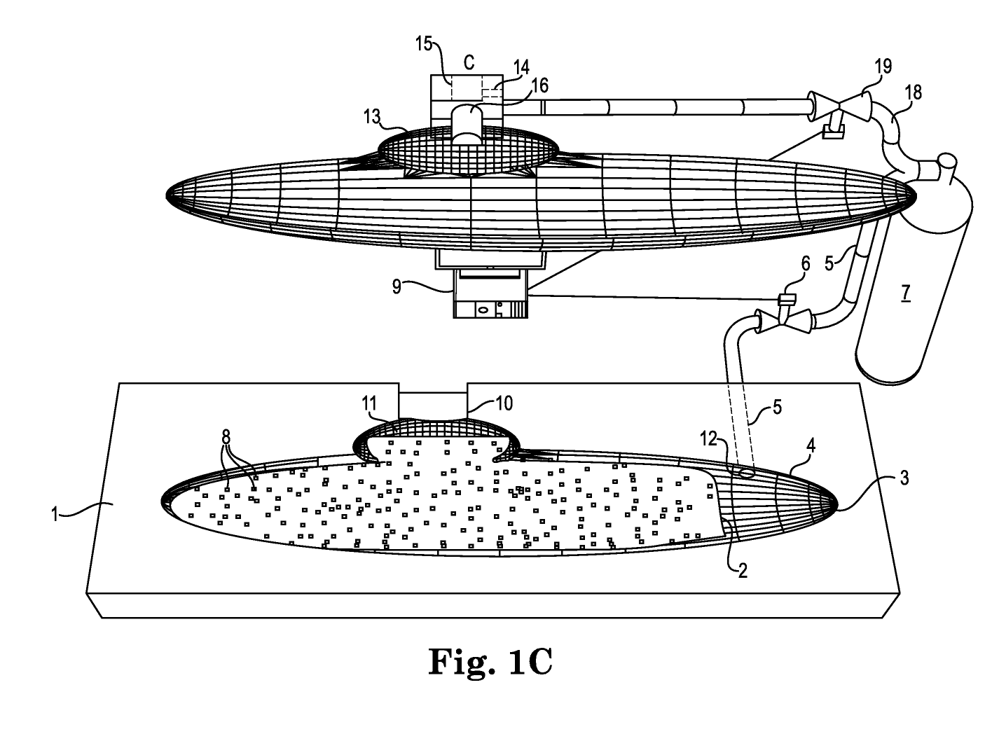

FIG. 1A shows a portion of an assembly of the invention prior to molding an article. First mold shell section 1 includes first mold shell section cavity portion 3 having first mold cavity portion edge 4 and notched region 10. First mold shell section cavity portion 3 includes first outer membrane 2 disposed within first mold shell section cavity portion 3 and affixed thereto at boundary 11 and edge 4. Thermoplastic pellets 8 are disposed on top of first outer membrane 2. Gas pressure source 7 provides gas via conduit 5 through valve 6 wherein valve 6 is controlled by computer 9. Gas released through valve 6 flows through orifice 12, disposed beneath first outer membrane 2 as controlled by computer 9. Portal conduit 18 is also supplied by gas pressure source 7 through valve 19, wherein gas released through valve 19 flows to junction 14 and into throughway 15 and finally to portal 16 as controlled by computer 9.

FIG. 1B shows a cutaway portion taken from line A-B in FIG. 1A. Visible in the cutaway is first mold shell section 1, having cavity 3, first mold cavity portion edge 4, conduit 5 and orifice 12, wherein first outer membrane 2 is disposed within cavity portion edge 4, over orifice 12. Thermoplastic pellets 8 are disposed on top of first outer membrane 2.

FIG. 1C shows all the features of FIG. 1A and further shows inner membrane 13 fluidly connected to portal 16. Inner membrane 13 is pressurized.

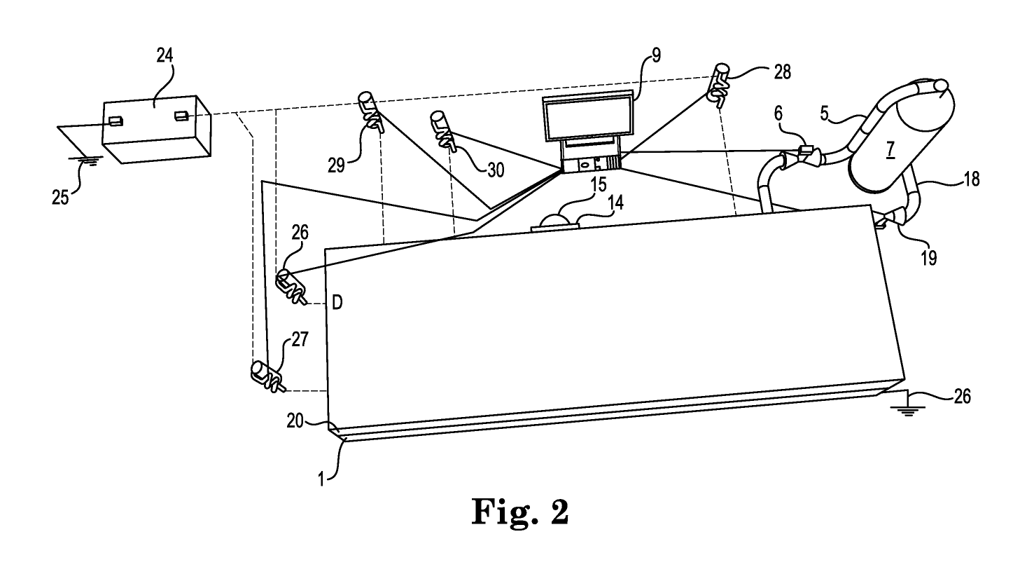

FIG. 2 shows an assembled mold assembly including first mold shell section 1, second mold shell section 20 attached to form a mold shell. Pressurized inner membrane (not visible) resides within the cavity formed by the assembled mold shell. During molding, gas pressure source 7 supplies gas through conduit 18 to valve 19 wherein the flow of gas through valve 19 is controlled by computer 9; gas issued through valve 19 flows to junction 14 and into throughway 15 and finally to portal 16 (not visible) and into the inner membrane (not visible). Electrical supply 24, grounded at ground 25, supplies electricity to second mold shell section varistor 26, first mold shell section varistor 27, inner membrane varistor 28, second outer membrane varistor 29, and first outer membrane varistor 30, wherein all varistors are controlled by computer 9. Mold shell sections 1, 20 conduct electricity and cause the mold shell to heat when computer 9 directs varistors 27, 26. Inner membrane and first and second outer membranes (not shown) conduct electricity and cause the membranes to heat when computer 9 directs varistors 28, 30, 29.

After molding and cooling, gas pressure source 7 supplies gas through conduit 5 to valve 6 wherein the flow of gas through valve 6 is controlled by computer 9; gas issued through valve 6 flows through orifice 12 underneath first outer membrane 2 as required to cause demolding.

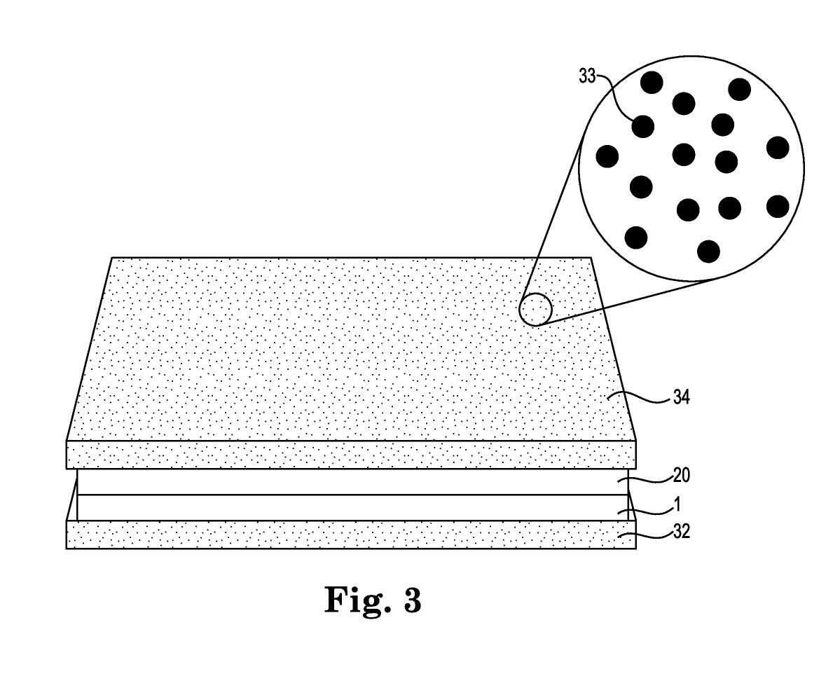

FIG. 3 shows first mold shell section 1 covered by first irradiation sleeve 32 and second mold shell section 20 covered by second irradiation sleeve 34. Each sleeve 32, 34 includes Co⁶⁰ domains 33. Sleeves 32, 34 are left in contact with mold shell sections 1, 20 after molding and cooling but before demolding for a selected period of time to incur toughening, hardening, or both of the molded article residing inside the mold shell.

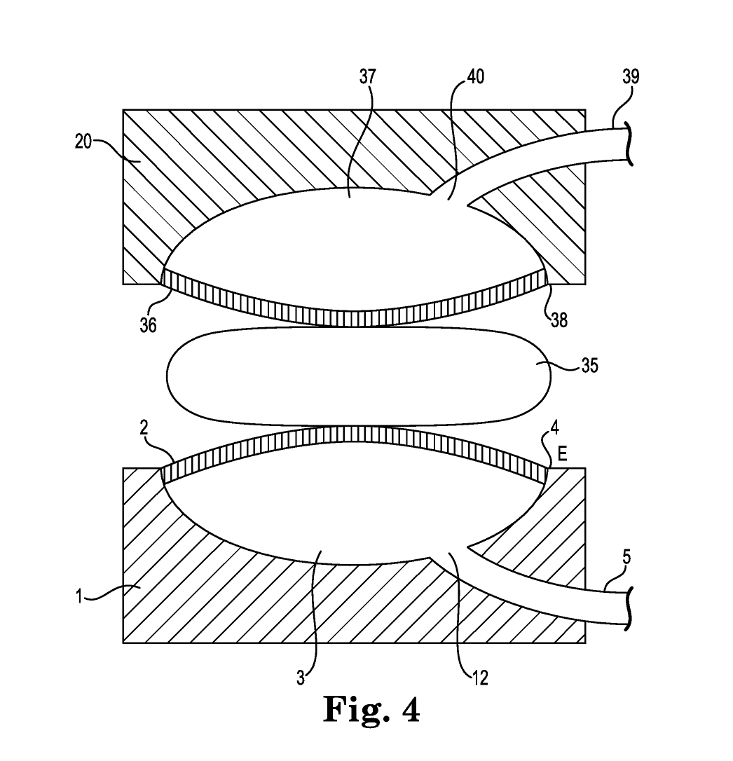

FIG. 4 shows a cutaway portion of first mold shell section 1, second mold shell section 20, and molded article 35 wherein the cutaway is taken from a line similar to A-B in FIG. 1A. Visible in the cutaway is first mold shell section 1, having cavity 3, first mold cavity portion edge 4, conduit 5 and orifice 12, wherein first outer membrane 2 is pressurized by gas flowing from conduit 5 through orifice 12. First outer membrane 2 is connected to first mold shell section 1 at cavity portion edge 4. Also visible in the cutaway is second mold shell section 20, having cavity 37, second mold cavity portion edge 38, conduit 39 and orifice 40, wherein second outer membrane 36 is pressurized by gas flowing from conduit 39 through orifice 40. Second outer membrane 36 is connected to second mold shell section 20 at cavity portion edge 38. Convex disposition of first and second outer membranes 2, 36 forced molded article 35 out of first and second mold shell sections 1, 20.

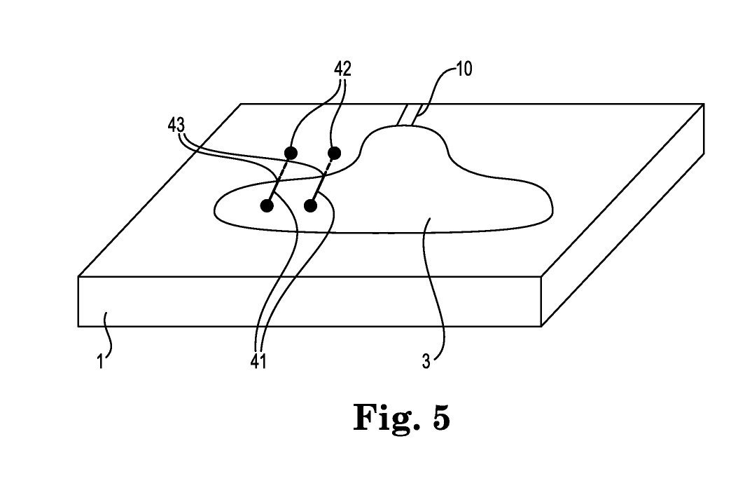

FIG. 5 shows a first mold shell section 1 including first mold shell section cavity portion 3 having first mold cavity portion edge 4 and notched region 10. Reinforcement bands 41 are attached to reinforcement attach points 37. After adding moldable material, assembling a mold assembly and molding an article in the presence of reinforcement bands 41, reinforcement bands 41 are severed at sever points 38 prior to or contemporaneously with demolding the molded article. In this manner, reinforcement bands 41 are made integral to the article.

The invention illustratively disclosed herein can be suitably practiced in the absence of any element which is not specifically disclosed herein. While the invention is susceptible to various modifications and alternative forms, specifics thereof have been described in detail. It should be understood, however, that the invention is not limited to the particular embodiments described. On the contrary, the intention is to cover modifications, equivalents, and alternatives falling within the spirit and scope of the invention as described herein. In various embodiments, the invention suitably comprises, consists essentially of, or consists of the elements described herein and claimed according to the claims.

Additionally each and every embodiment of the invention, as described here, is intended to be used either alone or in combination with any other embodiment described herein as well as modifications, equivalents, and alternatives thereof. The various embodiments described above are provided by way of illustration only and should not be construed to limit the claims attached hereto. It will be recognized that various modifications and changes may be made without following the example embodiments and applications illustrated and described herein, and without departing from the true spirit and scope of the claims.

1. A mold assembly comprising first and second mold shell sections adapted to be connected to form a mold shell defining a cavity; and a reversibly pressurized inner membrane fluidly connected to a source of pressure, wherein the assembly is formed by disposing the inner membrane within the cavity such that the cavity defines the outer boundary of an article to be molded, and the pressurized inner membrane defines the inner boundary of the article to be molded.

2. The mold assembly of claim 1 wherein the first and second mold shell sections conduct electricity.

3. The mold assembly of claim 1 wherein the inner membrane conducts electricity.

4. The mold assembly of claim 1 further comprising one or more reversibly pressurized outer membranes fluidly connected to a source of pressure and disposed within and attached to the first mold shell section, the second mold shell section, or both.

5. The mold assembly of claim 1 wherein the mold shell sections are formed from a glass, a glass-carbon fiber composite, a metal, a metal alloy, a metal-carbon fiber composite, a polymer, a polymer alloy, or a polymer-carbon fiber composite.

6. The mold assembly of claim 1 wherein the source of pressure is gas or hydraulic pressure.

7. The mold assembly of claim 1 wherein the reversibly pressurized inner membrane is capable of eversion.

8. The mold assembly of claim 1 further comprising one or more additional inner membranes.

9. A method of molding an article, the method comprising:
adding a moldable material to a first mold shell section and a second mold shell section, each mold shell section defining a portion of a cavity;
disposing a pressurized inner membrane proximal to at least the first mold shell section;
attaching the first and second mold shell sections to form a mold assembly defining a cavity, wherein the inner membrane is disposed within the cavity;
raising the temperature of the moldable material to between the T_{g} and Tₘ of the material, above the Tₘ of the material, or to a cure temperature of the material, while maintaining or increasing pressure to the inner membrane; and
reducing the temperature while maintaining or increasing pressure to the inner membrane.

10. The method of claim 9, further comprising adding one or more reinforcing elements to the moldable material prior to attaching the mold shell sections.

11. The method of claim 9, further comprising drying the moldable material prior to raising the temperature to between the T_{g} and Tₘ of the material, above the Tₘ of the material, or the cure temperature of the material.

12. The method of claim 9 wherein one or both of the cavity portions comprises one or more reversibly pressurized outer membranes attached thereto, and the one or more outer membranes are pressurized and depressurized one or more times between raising the temperature and reducing the temperature.

13. The method of claim 9 further comprising varying the pressure within the inner membrane after reducing the temperature while maintaining or increasing pressure to the inner membrane.

14. The method of claim 9 further comprising depressurizing the inner membrane, then detaching the first and second mold shell sections after reducing the temperature while maintaining or increasing pressure to the inner membrane.

15. The method of claim 14 wherein one or both of the cavity portions comprises one or more reversibly pressurized outer membranes attached thereto, and the one or more outer membranes are pressurized after detaching the first and second mold shell sections.

16. The method of claim 14 wherein the depressurizing further comprises everting the inner membrane.

17. The method of claim 9 further comprising covering at least a portion of the mold assembly with a Co⁶⁰ infused sheet after reducing the temperature.

18. A molded thermoplastic or thermoset article formed by the method of claim 9.

19. The molded thermoplastic or thermoset article of claim 18 wherein the article is a complex article.
